(19) United States
(12) Patent Application Publication
(10) Pub. No.: US 2013/0090986 A1
(43) Pub. Date: Apr. 11, 2013

(54) System for and Method of Monitoring Viewer Advertisement Content

(71) Applicant: Jebbit, Inc., Hopkinton, MA (US)

(72) Inventors: Peter CASINELLI, Medway, MA (US); Tom COBURN, Hopkinton, MA (US)

(73) Assignee: JEBBIT, INC., Hopkinton, MA (US)

(21) Appl. No.: 13/645,903

(22) Filed: Oct. 5, 2012

Related U.S. Application Data
(60) Provisional application No. 61/544,628, filed on Oct. 7, 2011.

(51) Int. Cl. G06Q 10/00

(52) U.S. Cl. 705/7.32

(57) ABSTRACT

A system for and a method of monitoring viewer advertisement content is disclosed. A method of evaluating a level of user understanding of video content including receiving information characterizing a video content item and selecting a validation prompt based on the information characterizing the video content item. The method also includes providing the validation prompt for presentation to the user and receiving user input in response to the validation prompt. The method further includes evaluating the user input against predetermined evaluation criteria corresponding to the validation prompt and recording a result of the evaluation of the user input.

### CROSS-REFERENCE TO RELATED APPLICATIONS

This application claims the benefit under 35 U.S.C. §119(e) to U.S. Provisional Patent Application No. 61/544,628, entitled System for and Method of Monitoring Viewer Advertisement Content, filed on Oct. 7, 2011, the contents of which are incorporated by reference herein.

### BACKGROUND OF THE INVENTION

1. Field of Invention

The invention generally relates to outbound communications from businesses, more specifically, to the subsequent validation that a user has understood a concept by successfully validating their knowledge against specified criteria.

2. Description of Related Act

Today's advertisers, enterprises, companies and marketers (hereafter referred to as businesses) have the ability to reach and interact with consumers, customers and potential customers (hereafter referred to as users) on many devices. Computers, smart phones, tablets and TVs, for example, are all technologies that allow businesses to present their unique set of goods and services to users on an interactive platform. Typically, this is done through, but not limited to, different marketing and advertising campaigns. Some examples of these outbound communications include businesses purchasing advertising space in the search results of various search engine providers on computers, pop-up advertisements that are displayed during the use of applications on smartphones and tablets, and advertisements played in between segments of currently watched program on a TV.

In many instances of these contact points between businesses and users, the user either passively absorbs the marketing material or ignores the content altogether. Companies have difficulty validating that a user has truly understood the meaning, message, or fact that the business intended to relay to the user.

This disclosure outlines the mechanism by which businesses can engage users in a new way by validating the user has understood specific information and rewarding users for successfully validating that they have understood this information. The present disclosure also relates to rewarding the user's successful validation of such knowledge with some form or a reward.

### BRIEF SUMMARY OF THE INVENTION

One aspect of the invention includes a system for and a method of monitoring viewer advertisement content.

Another aspect of the invention includes a method of evaluating a level of user understanding of video content including receiving information characterizing a video content item and selecting a validation prompt based on the information characterizing the video content item. The method also includes providing the validation prompt for presentation to the user and receiving user input in response to the validation prompt. The method further includes evaluating the user input against predetermined evaluation criteria corresponding to the validation prompt and recording a result of the evaluation of the user input.

Under a further aspect of the invention, the evaluation criteria includes a correct answer, and the recording the evaluation of the user input includes recording a reward credited to the user upon a condition in which the result indicates the user input matches the correct answer.

Under another aspect of the invention, the evaluation criteria includes a correct answer and at least one incorrect answer, and the recording the evaluation of the user input includes (i) recording a first reward credited to the user upon a condition in which the result indicates the user input matches the correct answer, or (ii) recording a second reward credited to the user upon a condition in which the result indicates the user input matches one of the incorrect answers.

Under still another aspect of the invention the reward includes a monetary credit deposited in an account associated with the user.

Under a further aspect of the invention, the video content item is provided by a video content provider, and the method includes informing the video content provider of the result.

Under still another aspect of the invention, the validation prompt is provided by a validation prompt provider, and the method includes the validation prompt provider receiving a monetary credit from the video content provider in response to the informing the video content provider of the result.

Under a further aspect of the invention, the evaluation criteria includes a correct answer, and the validation prompt is provided by a validation prompt provider. The method also includes the validation prompt provider receiving a monetary credit from the video content provider upon a condition in which the result indicates the user input matches the correct answer.

Under yet another aspect of the invention, the providing the validation prompt for presentation to the user includes displaying the validation prompt before, during, or after the display of the video content item.

Under still a further aspect of the invention, the validation prompt is displayed on at least one of a mobile computing device, smartphone, tablet computing device, television system, and Internet access device.

Under a further aspect of the invention, the video content item includes at least one of an advertisement, television program, movie, web clip, website, blog, photograph, image, collection of text, and graphics.

Under another aspect of the invention, the validation prompt includes a multiple choice question.

Under still another aspect of the invention, the validation prompt includes a task for the user to complete, the task including at least one of (i) matching at least one similar image with a presented image, (ii) ordering images according to an instruction set, and (iii) selecting an image from a plurality of images, (iv) completing a text input, and (v) unscrambling a word or sentence.

Another aspect of the invention includes systems for performing the methods disclosed above.

Any of the aspects above can be combined with any of the other aspects disclosed above or below.

### BRIEF DESCRIPTION OF THE SEVERAL VIEWS OF THE DRAWINGS

FIG. 1 illustrates a Validation Pane imposed on video content.

FIG. 2 illustrates a Validation Pane imposed on web content.

FIG. 3 illustrates a flow of Validation Instance process.

FIG. 4 illustrates a flow of Validation Instance process.

FIG. 5 illustrates a flow of Reward Accruement.

FIG. 6 illustrates a connected devices interacting with network components and applications during a Validation Instance.

FIG. 7 illustrates a flow of successful Validation Instance communication.

FIG. 8 illustrates a flow of successful Validation Instance communication.

FIG. 9 is a flowchart showing one implementation of the process by which the business chooses to pay for the services outlined above on a “Cost-Per-Correct-Answer” (or CPCA) basis.

### DETAILED DESCRIPTION

For those familiar with marketing campaigns and content creation, an essential component is to relay information to the target. Success hinges on whether or not this information is understood and resonates with the targeted segment. This disclosure outlines embodiments by which users can be engaged in a new way by validating the user has understood specific information and rewarding users for successfully validating that they have understood this information. Embodiments of the prevention also rewarding the user's successful validation of such knowledge with some form of a reward.

This disclosure describes embodiments for validating user knowledge gained from an interaction, hereafter referred to as a Validation Instance, with a business or company. A Validation Instance refers to an event in which a user is posed a question or request to perform a task and the user's answer or sequent performance of the task is evaluated. The question or task can be embodied in, but is not limited to, questions regarding information presented in a video content item (e.g., an advertisement) or in web content, or a task, which can range from, but is not limited to, reordering images, matching similar images within a selection, selecting an image from a set of images, completing a text input, and/or unscrambling a word or sentence as it relates to specific video or web content. The first part of the Validation Instance, in which the user is presented with a question or task, is referred to herein as a Validation Prompt.

A Validation Prompt may be presented to the user on, but is not limited to, a pane imposed upon a video viewing session within an application, Internet browser, TV screen interface, a mobile device interface, video application, video player or any other user interface. Alternatively, a Validation Prompt may be presented to the user in, but is not limited to, a pane imposed upon an Internet browsing session within an application, Internet browser, TV screen interface, mobile device, or any other user interface.

In one embodiment of the invention, after being posed the Validation Prompt, the user may either answer the question or complete the task in order to validate that specific knowledge relative to video or web content has been successfully gained. Upon completion of the Validation Instance, if the user does not successfully validate his or her knowledge, then in some cases the user may not be rewarded. However, if a user does successfully validate having accrued specific knowledge relative to the video content item (e.g., advertisement), then that user may be rewarded in some fashion and a business may pay the Validation Service Provider.

In some embodiments of the invention, the Validation Service Provider refers, but is not limited, to an internal division of the business presenting content to be validated, or another business, contractor, partner, or other third party, that is responsible for hosting information need for the Validation Instance, sending all or part of the information for the Validation Instance, checking user feedback from the Validation Prompt against predefined criteria, and/or determining what further action, if any, is to be taken. This further action could include, but is not limited to, rewarding the user. The Validation Prompt posed by the Validation Service Provider can occur, but is not limited to, while browsing web content on the Internet, while watching video on a computer or connected device, while watching video on a TV that is connected to a managed network, such as a cable network, and/or on an application on a mobile device, connected device, connected TV, or tablet.

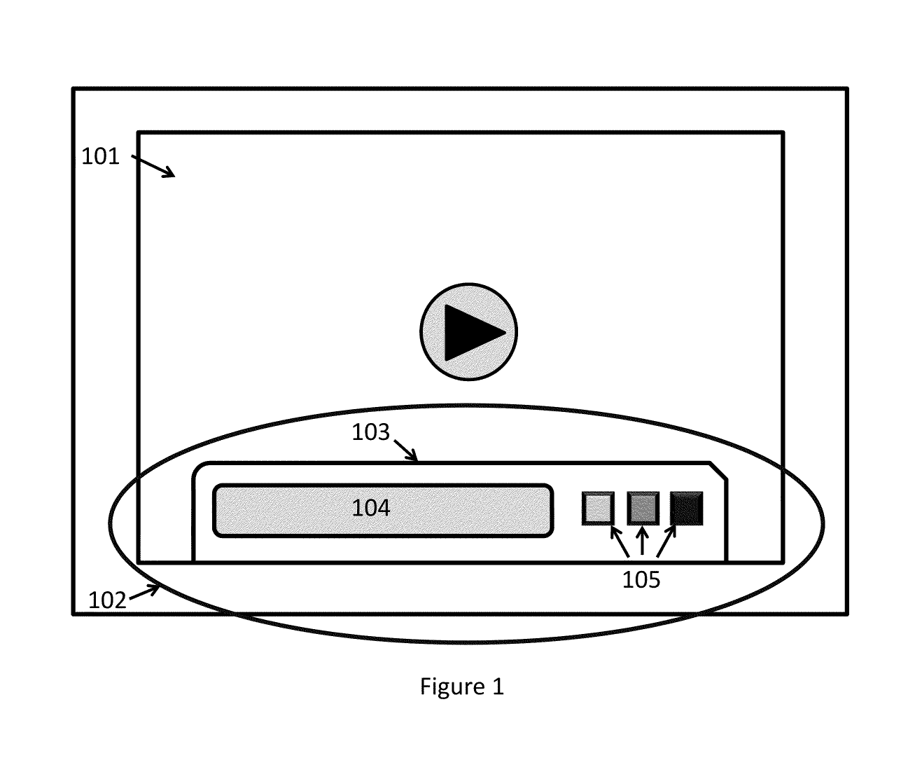

In one embodiment of this invention, a Validation Instance may occur in, but is not limited to, connected devices, such as smartphones, tablets, Internet access devices, computers, connected TVs, and television sets, which are connected to Validation Service Providers through a managed network, such as a cable network, IPTV network, or an IP network, or an unmanaged network. An embodiment of a Validation Prompt 102 can be found in FIG. 1. In FIG. 1, there is an example of a Validation Pane 103 overlapping video content 101 or on the screen or interface before or after video content has been presented. A Validation Pane can be, but is not limited to, a tab overlaying video or web content in which a question or task as well as answers to these questions or objects related to the task are presented to the user. In an embodiment of this invention, a Validation Pane could be a tab that overlays video content where a question and multiple-choice answers are presented to the user for the purposes of a Validation Instance. In the Validation Pane, the user would be posed a question, task, or other validation 104 as outlined by the prior definition of the Validation Instance, and is presented multiple choice answers 105 to choose from and select in order to validate the specific knowledge gained while consuming video content.

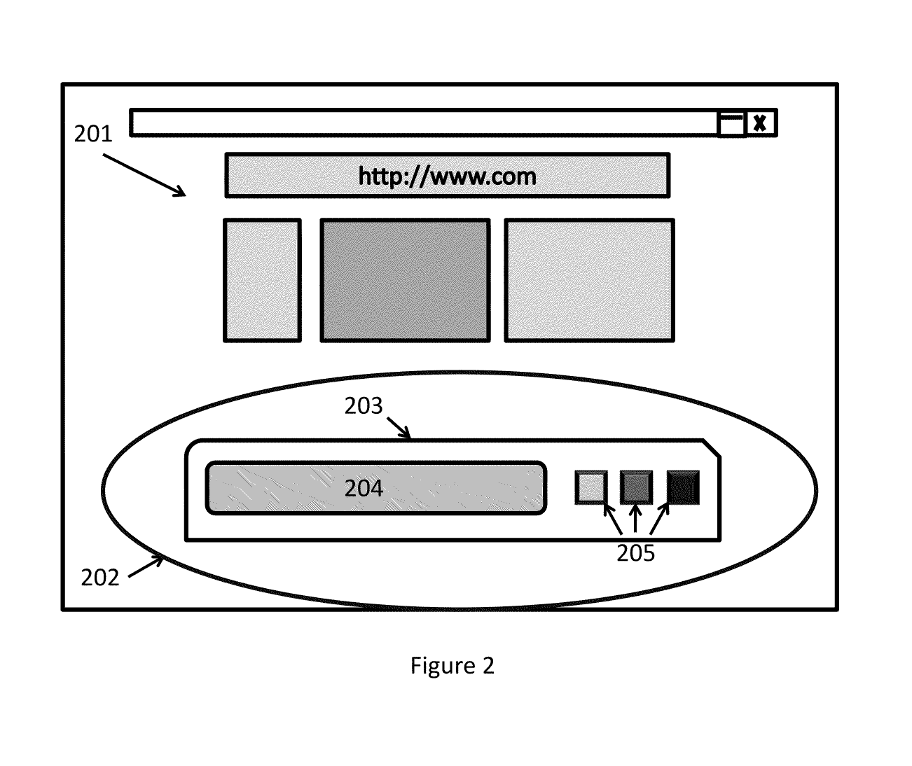

In another embodiment of this invention, an embodiment of a Validation Prompt 202 can be found in FIG. 2. A Validation Pane 203 overlays web content 201 (i.e., video content available via the Internet), which can range from, but is not limited to, a website, blog, photographs, images, text, or graphics. In an embodiment of this invention, a Validation Pane is a tab that overlays web content where a question and multiple choice answers are presented to the user for the purposes of a Validation Instance. In the Validation Pane, the user could be posed a question, task, or other validation 204 as outlined by the prior definition of the Validation Instance, and is presented multiple choice answers 205 to choose from and select in order to validate the specific knowledge gained while consuming video content.

In some embodiments, a Validation Instance can validate whether or not user choice and behavior meets specific criteria and then may reward the user if so desired. In one embodiment of this invention, video content is displayed to the user on, but not limited to, a website, a mobile device, a tablet, a computer, or a TV. In one possible implementation of this, a Validation Prompt is posed to the user during the course of the video. The viewer can then respond to the Validation Prompt by, but not limited to, answering a question or reordering images (or any other responses disclosed herein), and submitting his or her validation to the Validation Service Provider. This validation is compared to criteria that may be stored on an application on the device itself or on a server connected to the device through a managed or unmanaged network, where the proper response by the Validation Service Provider is determined. Successful validation may result in, but is not limited to, rewards, electronic currency, true currency, coupons or no action. Failed validation may result in, but is not limited to, rewards, electronic currency, true currency, coupons or no action. The company using the services of the Validation Service Provider can reward the user through the Validation Pane, user login, user account or some other mechanism. The company using the services of the Validation Service Provider can also pay the Validation Service Provider for the Validation Instance service.

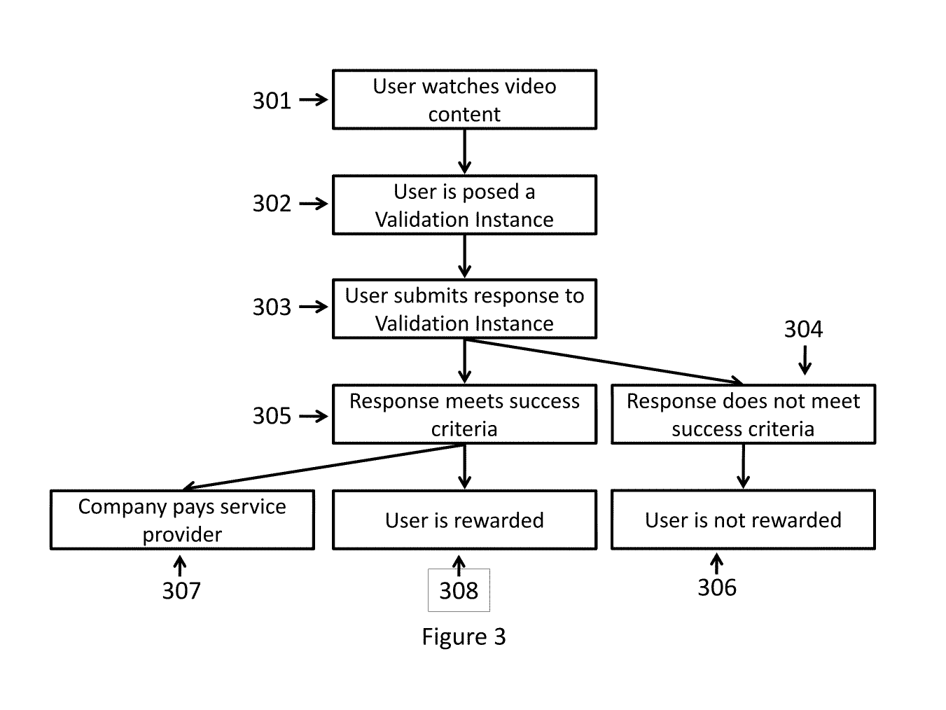

In an embodiment of a Validation Instance, regardless of platform, the Validation Instance has a basic flow that leads from the ingestion of content to possibly giving a reward. In FIG. 3, the user is watching video content on a device 301. While watching this video content, the user is posed a Validation Prompt related to a specific advertisement that has just been viewed 302. In this instance, the Validation Prompt takes the form of a Validation Pane imposed upon the video content during and after it is being played out to the user, which contains a question with multiple-choice answers. After discerning the best answer to the question related to the video content, the user submits his or her response 303 via the Validation Pane. If the answer submitted by the user is incorrect 304, i.e. it does not meet the predefined criteria for a successful answer, then, in this embodiment of the invention, that user is not rewarded 306. However, for the purposes of this example, the user does in fact successfully answer the multiple-choice question 305, i.e. the response meets the success criteria. Once success has been established, the user is given a reward 308 and the advertiser submits a payment to the Validation Service Provider 307. In this example, the advertiser could pay the Validation Service Provider because they have provided a platform through which the advertiser ensured that a specific message relative to its brand, product, or communications had been successfully understood.

In another embodiment of this invention, a Validation Instance can occur while browsing web content, whether on the Internet, through an application, through another website, or any other interface or display. A user could browse web content, during the course of which he or she can be posed a Validation Prompt about content that has, but is not limited to, already been viewed, is related to content that has been viewed, or content that has yet to be viewed. Once the user believes that he or she has gained the appropriate knowledge, that user can validate the knowledge by submitting a response. This validation is compared to criteria that may be stored on an application on the device itself or on a server connected to the device through a managed or unmanaged network, where the proper response by the Validation Service Provider is determined. Successful validation may result in, but is not limited to, rewards, electronic currency, true currency, coupons or no action. Failed validation may result in, but is not limited to, rewards, electronic currency, true currency, coupons or no action.

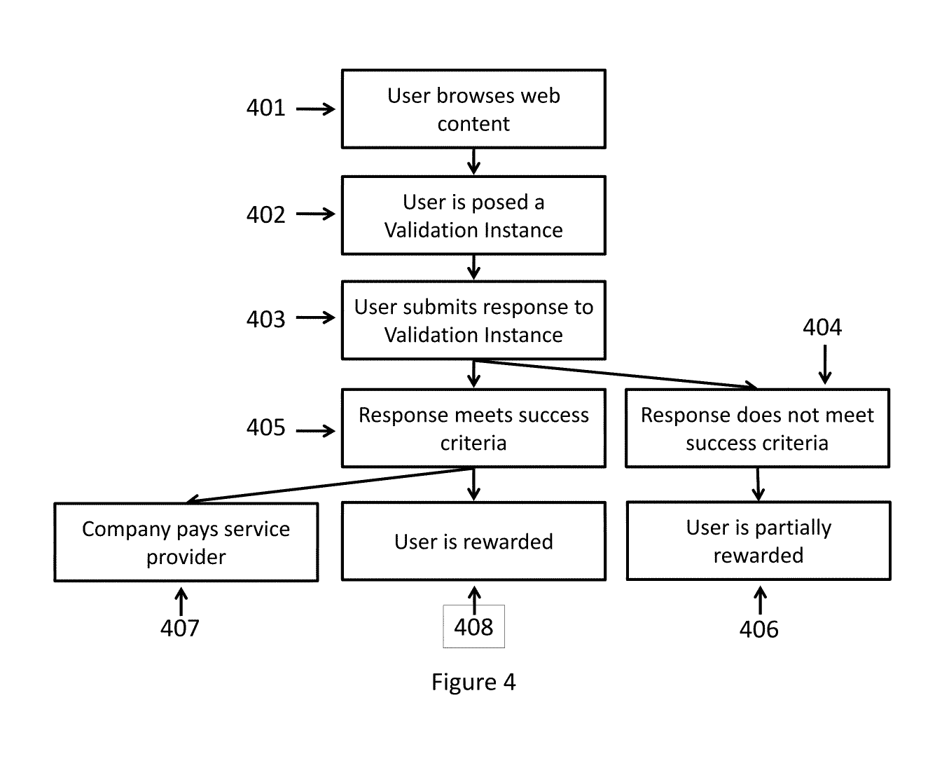

In another embodiment of the process of completing a Validation Instance, found in FIG. 4, the user is browsing web content on a computer 401. While browsing this web content, the user is posed a Validation Prompt related to information that is located on the page 402. In this instance, the Validation Prompt takes the form of a Validation Pane imposed upon the web content that contains a question with multiple-choice answers. After discerning the best answer to the question related to the web content, the user can submit his or her response 403 via the buttons in the Validation Pane. If the answer submitted by the user is incorrect 404, i.e. if it does not meet the predefined criteria for a successful answer, then, in this embodiment of the invention, the user could be partially rewarded. For example, if a fact-based question is posed and the user selects an answer that shows partial knowledge of the fact, then an advertiser or business may choose to reward the user 406. Furthermore, the advertiser or business may choose to reward partial knowledge with a reward that is of lesser value than the reward for the actual correct answer. However, for the purposes of this example, the user does in fact successfully answer the multiple-choice question 405, i.e. if the answer meets the success criteria. Once success has been established, the user is given a reward 408 and the advertiser submits a payment to the Validation Service Provider 407. In this example, the advertiser could pay the Validation Service Provider because they have provided a platform through which the advertiser ensured that a specific message relative to its brand, product, or communications had been successfully understood.

In an embodiment of this invention, businesses may choose to reward users who successfully or unsuccessfully complete a Validation Instance. The process of receiving rewards, including but not limited to rewards, electronic currency, true currency, or coupons, and accruing them in an account is referred to as Validation Reward Accruement.

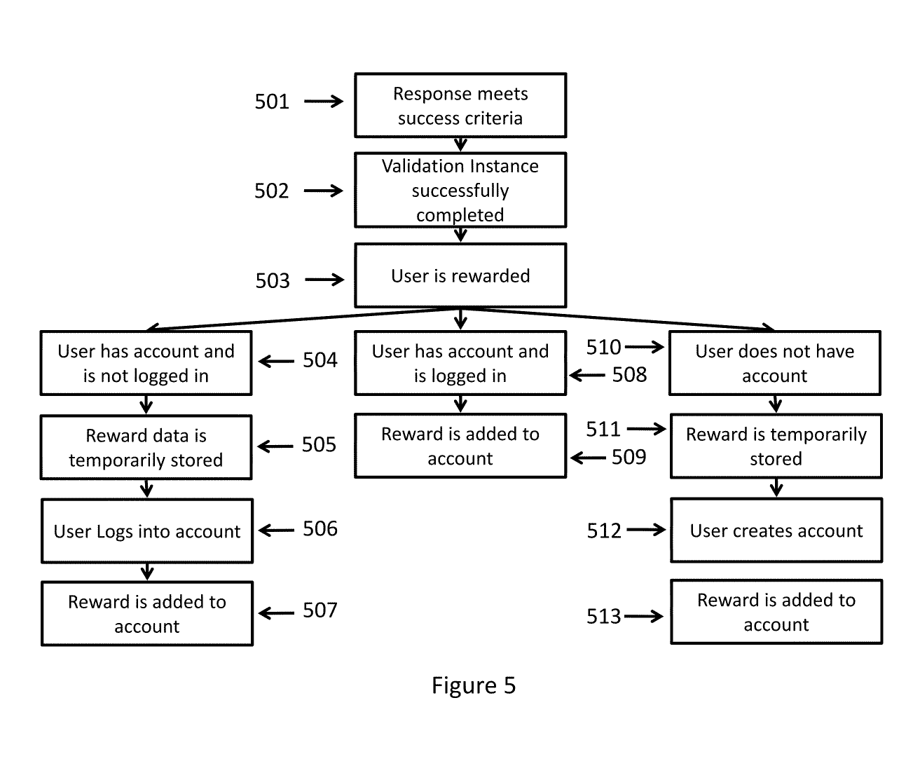

An embodiment of a Validation Reward Accruement is outlined in FIG. 5. In an implementation of the invention, the response of the user meets the specified criteria 501, causing a successful completion of a Validation Instance 502. In this example, it is determined that the user will be rewarded for the successful completion of the Validation Instance 503.

In an embodiment of this process, there are three possible outcomes for a user who receives a reward for successful validation. In the first, a user already has an account with the Validation Service Provider and is not currently logged into this account 504. In this case, the rewards are temporarily stored in, but not limited to, cookies, IP addresses, MAC addresses or computer memory 505, and the user is prompted to log into his or her account. Once the user has logged into his or her account 506 the reward is transferred to the account 507 and the Validation Reward Accruement is complete.

In the second outcome, a user already has an account with the Validation Service Provider and is currently logged into that account 508. In this case the reward is simply transferred to the account 509.

In the third outcome, a user who does not have an account with the Validation Service Provider 510 successfully completes a Validation Instance. In this case, the reward that has just been accrued is temporarily stored 511, as previously defined, while the user can create an account with the Validation Service Provider. If the user decides to create an account and successfully completes this task (512) then the reward is added to that newly created account (513).

When an embodiment of this invention includes a Validation Instance that can reward a user, submitted responses can be evaluated and the success or failure of these responses can be relayed to the user. Such an embodiment of this invention could include a mechanism by which a Validation Prompt is sent to the user, whether before, during or after video or web content, and presented to the user in some kind of format, such as but not limited to a Validation Pane or other interface, on a device, including but not limited to a smartphone, TV, or laptop. This embodiment can also include the mechanism by which the user can submit a choice or response for the Validation Instance for review, and the mechanism by which the Validation Service Provider receives, evaluates and relays the success or failure of this response back to the user.

In an embodiment of this invention, responses are sent to a Validation Server, which is defined as a server hosted by a Validation Service Provider for the purposes of providing the Validation Instance service to, but not limited to, its customers, partners, or other third-party relations, or any other server. The Validation Instance can also pass along user information, which may be cookies, IP addresses, or MAC addresses. A user can log in with an account and be persistently logged into the Validation Service Provider's system or other system, allowing the one login to cover multiple Validation Instances. In addition, if the user is not logged in, temporary files, such as, but not limited to, cookies or data stored in a video application or device, can store reward information and can be sent to the Validation Server. This data could record the rewards gained by the user during this specific Validation Instance or multiple Validation Instances. If not logged in, the Validation Server will prompt the user to log in to proceed with Reward Accruement. If the user does not have an account, a request can be sent to the Validation Server or other server to create an account, which after successfully created, will allow Reward Accruement of those rewards gained from Validation Instances.

In one embodiment of this invention, a user's video content may be requested from a video server, which could then request an ad from an ad server and a Validation Instance from a Validation Server. However, layout of servers as individual components is merely an example. In other instances, any functionality of any one of the servers can be combined within one or more servers in one or more locations. Essentially, one server could perform the functions of all three previously mentioned servers (video, ad and Validation Server) or additional functions as well. In addition, multiple, multi-purpose servers could exist in different locations containing many banks of such servers.

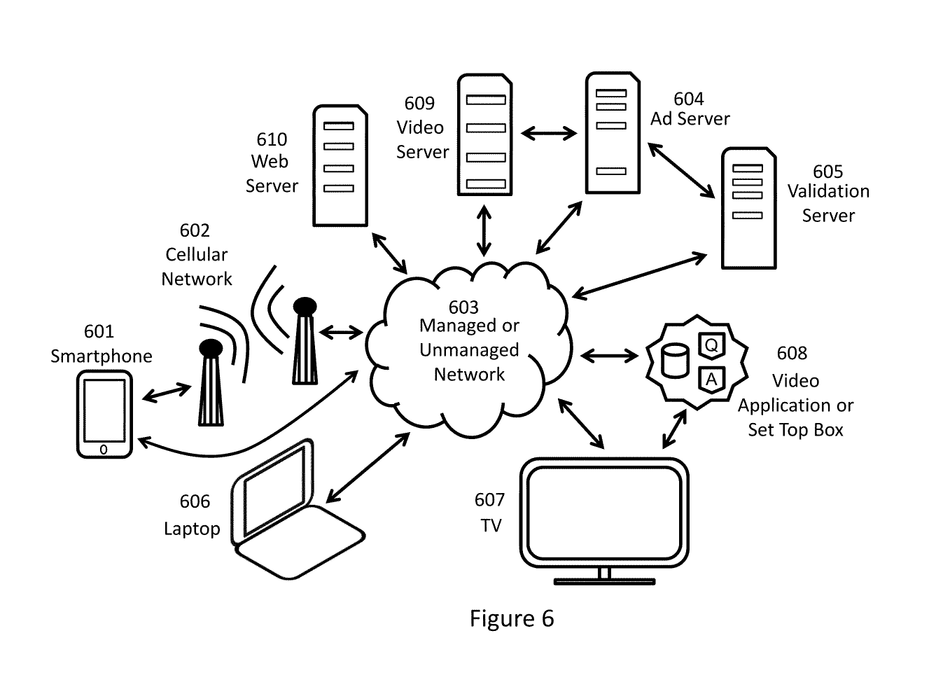

In an implementation of this invention, found in FIG. 6, a user can click a link to begin watching an online video clip on a laptop 606. To access this video, the laptop will send a request to a video server 609 over a managed or unmanaged network 603. Prior to loading the video, the video player or video server 609 sends a request over a managed or unmanaged network 603 to an ad server 604 for a video advertisement to play before, during or after the video session. This ad server 604 will then make a request to the Validation Server 605. This ad server 604 will request a Validation Instance for the specific advertisement that has been selected to play before, during, or after the user's selected video. When the video ad is being requested and the ad server 604 may check the Validation Server for available Validation Instances, user data, such as a cookie, login information, or account information that can contain, but is not limited to, demographic information and account information for the account that will take part in Reward Accruement as previously described, is also sent to the Validation Server 605. This provides the basis for the Reward Accruement process as described in FIG. 5.

The correct Validation Instance can be determined by, but not limited to, a database that stores unique identifiers for commercials and their respective Validation Instances. Once the appropriate Validation Instance for the video advertisement has been selected by the Validation Server 605, the video server 609 sends both the video advertisement and the Validation Prompt to the laptop 606 to be displayed before, during or after the video session. After watching the video advertisement, for example, the user can select a choice or response from the Validation Prompt. This submission can be sent from the laptop 606 to the ad server 604 over the managed or unmanaged network 603, which the ad server 604 will then send to the Validation Server 605, or, in another implementation of this process, the ad server 604 could be bypassed and the submitted answer could be sent directly to the Validation Server 605.

In any case, the Validation Server 605 receives the submitted response and evaluates the response against criteria stored on the Validation Server 605. This process of validating the responses can take the form of, but is not limited to, a database in which the video advertisement information, possible answers and correct answers are stored and can be accessed and evaluated relative to the answer submitted by the user in order to determine whether or not the Validation Instance is successful and, optionally, if the user should be rewarded. Then, the Validation Server 605 can send the outcome of the Validation Instance directly to the user. Additionally, the outcome could be sent to the Ad Server 604, which could either send the outcome across a managed or unmanaged network 603 to the laptop 606 or can send the outcome to the video server 609, which would then send the outcome over a managed or unmanaged network 603 to the laptop 606.

In another implementation of this invention, a user can begin watching an online video clip on a smartphone or other mobile device 601. To access this video, the smartphone 601 will send a request to a video server 609 over a cellular network 602 or a managed or unmanaged network 603. Prior to loading the video, the video player or the video server 609 sends a request over a managed or unmanaged network 603 to an ad server 604 for a video advertisement to play before, during or after the video session. This ad server 604 will then make a request to the Validation Server 605. This ad server 604 will request a Validation Instance for the specific advertisement that has been selected to play before, during, or after the user's selected video. When the video ad is being requested and the ad server 604 checks the Validation Server 605 for available Validation Instances, user data of the user viewing the video and ad content, such as a cookie, login information, or account information that can contain, but is not limited to, demographic information and account information for the account that will take part in Reward Accruement as previously described, is also sent to the Validation Server. This provides the basis for the Reward Accruement process as described in FIG. 5.

The correct Validation Instance can be determined by, but is not limited to, a database that stores unique identifiers for commercials and their respective Validation Instances. Once the appropriate Validation Instance for the video advertisement has been selected by the Validation Server 605, the video server 609 sends both the video advertisement and the Validation Prompt to the smartphone 601 over a managed or unmanaged network 603 or a cellular network 602 to be displayed before, during or after the video session. After watching the video advertisement, for example, the user can select a choice or response from the Validation Instance. This submission can be sent from the smartphone 601 to the ad server 604 over the managed or unmanaged network 603 or cellular network 602, which will then send the submission to the Validation Server 605, or, in another implementation of this process, the ad server 604 could be bypassed and the submitted answer could be sent directly to the Validation Server 605.

In any case, the Validation Server 605 receives the submitted response and evaluates the response against criteria stored on the Validation Server 605. This process of validating the responses can take the form of, but is not limited to, a database in which the video advertisement information, possible answers and correct answers are stored and can be accessed and evaluated relative to the answer submitted by the user in order to determine whether or not the Validation Instance is successful and, optionally, if the user should be rewarded. Then, the Validation Server 605 can send the outcome of the Validation Instance directly to the user through the managed or unmanaged network 603 or cellular network 602. Additionally, the outcome could be sent to the Ad Server 604 which could either send the outcome across a managed or unmanaged network 603 or cellular network 602 to the smartphone 601 or it could send the outcome to the video server 609, which would then send the outcome over a managed or unmanaged network 603 or cellular network 602 to the smartphone 601.

In a third implementation of this invention, a user can watch video on a TV 607. In this example, to access this video the TV will send a request to a video server 609 over a managed or unmanaged network 603. This could be done through a video application or a set top box 608. Prior to loading the video, the video server 609 sends a request over a managed or unmanaged network 603 to an ad server 604 for a video advertisement to play before, during or after the video session. This ad server 604 will then make a request to the Validation Server 605. This ad server 604 will request a Validation Instance for the specific advertisement that has been selected to play before, during, or after the user's selected video. When the video ad is being requested and the ad server 604 checks the Validation Server 605 for available Validation Instances, user data of the user viewing the video and ad content, such as a cookie, login information or account information that can contain, but is not limited to, demographic information and account information for the account that will take part in Reward Accruement as previously described, is also sent to the Validation Server 605. This provides the basis for the Reward Accruement process as described in FIG. 5.

The correct Validation Instance can be determined by, but not limited to, a database that stores unique identifiers for commercials and their respective Validation Instances. Once the appropriate Validation Instance for the video advertisement has been selected by the Validation Server 605, the video server 609 sends both the video advertisement and the Validation Prompt to the TV 607 to be displayed in the before, during or after the video session. After watching the video advertisement, for example, the user can select a choice or response from the Validation Instance. This submission can be sent from the TV 607 to the ad server 604 over the managed or unmanaged network 603 and could also be sent through a video application or set top box 608 to the managed or unmanaged network 603, which will then send the submission to the Validation Server 605, or, in another implementation of this process, the ad server 604 could be bypassed and the submitted answer could be sent directly to the Validation Server 605.

In any case, the Validation Server 605 receives the submitted response and evaluates the response against criteria stored on the Validation Server 605. This process of validating the responses can take the form of, but is not limited to, a database in which the video advertisement information, possible answers and correct answers are stored and can be accessed and evaluated relative to the answer submitted by the user in order to determine whether or not the Validation Instance is successful and, optionally, if the user should be rewarded. Then, the Validation Server 605 can send the outcome of the Validation Instance directly to the TV 607 through the managed or unmanaged network 603 and additionally through a video application or set top box 608. Additionally, the outcome could be sent to the Ad Server 604, which could either send the outcome across a managed or unmanaged network 603 to the TV 607 or it could send the outcome to the video server 609, which would then send the outcome over a managed or unmanaged network 603 to the TV 607.

In one embodiment of the example of a cable TV subscriber, an implementation of a reward system could be as follows: when the user successfully completes a Validation Instance, a reward could be a credit towards a monthly cable TV bill. In this instance, the user would pay attention to video advertisements in order to reduce monthly cable costs, advertisers would successfully pass knowledge and messaging to their viewers, and the Cable TV provider would be paid by the advertiser for the successful Validation Instances.

In a fourth implementation of this invention, a user can browse web content on a laptop 606. While browsing web content, the web server 610 will send a request over a managed or unmanaged network 603 to a Validation Server 605. This web server 610 will request a Validation Instance, for example, for the specific content displayed before, during, or after the user's browsing time. The web server 610 checks the Validation Server 605 for available Validation Instances and user data of the user viewing the content, such as a cookie, login information, or account information that can contain, but is not limited to, demographic information and account information for the account that will take part in Reward Accruement as previously described, is also sent to the Validation Server 605. This provides the basis for the Reward Accruement process as described in FIG. 5.

The correct Validation Instance can be determined by, but not limited to, a database that stores unique identifiers for content and Validation Instances. Once the Validation Server 605 has selected the appropriate Validation Instance for the video advertisement, the web server 610 sends the Validation Prompt to the laptop 606 to be displayed in the interface, as described in FIG. 2. After browsing the web content, the user can select a choice or response in the Validation Prompt. This submission can be sent from the laptop 606 over the managed or unmanaged network 603 to the Validation Server 605. The Validation Server 605 receives the submitted response and evaluates the response against criteria stored on the Validation Server 605. This process of validating responses can take the form of, but is not limited to, a database in which the video advertisement information, possible answers and correct answers are stored and can be accessed and evaluated relative to the answer submitted by the user in order to determine whether or not the Validation Instance is successful and, optionally, if the user should be rewarded. Then, the Validation Server 605 can send the outcome of the Validation Instance directly to the user over a managed or unmanaged network 603 to the laptop 606.

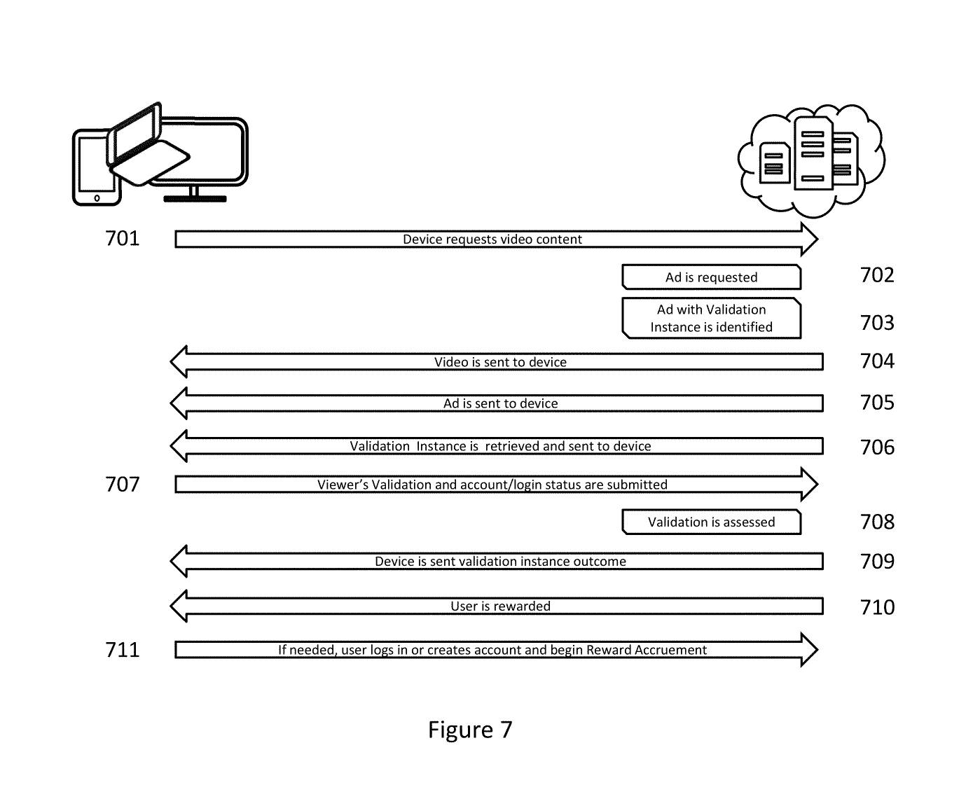

The following is a description (illustrated by FIG. 7) of one implementation of the process by which the correct Validation Instance is selected for a video advertisement, the submitted response by the user is evaluated, and, if necessary, the user is rewarded. Once the viewer selects the video from his or her device, a request is sent to the video server 701. The video server then requests an ad from the ad server to play before, during or after the video is played 702. In turn, the ad server searches for a video advertisement that has a Validation Instance associated with it to display to the viewer 703. In one implementation of this, a match between a unique identifier of the video advertisement asset with a Validation Instance stored in a database in the Validation Server would notify the ad server of that match. Then the video is sent to the device 704, the ad is sent to the device 705 and the Validation Prompt is sent to the device 706. Once all this information has been received, the user submits a Validation Instance along with account or login information to the Validation Server 707. The Validation Server assesses whether or not the validation submitted by the user successfully meets the success criteria 708. The device is then notified whether or not the user was successful 709. For the purposes of this example, the user successfully completes the Validation Instance. For successful completion of this example of a Validation Instance, the user is rewarded 710. Finally, if needed, the user can either login or create an account in order to gain rewards through Reward Accruement 711.

In an implementation of this invention that would coincide with the processes outlined in FIG. 7 it is necessary to retrieve the Validation Instance 706, validate the success of the Validation Instance 708, and track rewards 710 and 711. In an example of how to retrieve a Validation Instance 706, prior to watching a video, a user must watch a video advertisement. Before this video advertisement is served by the ad server, the video player or the ad server will make an API request to the Validation Server using server side scripting including, but not limited to, PHP and Java. Some common functionality of this API could include, but is not limited to, functions to retrieve Validation Instances associated with video identifications, compare Validation Instances against the Validation Service Provider's database, reward users based on Validation Instances, and retrieve user data including, but not limited to, reward balances, and Validation Instance interaction statistics.

In this API request, parameters including, but not limited to, a video identification, a video web site, user information that may have been stored in a cookie or carried across a persistent login, and demographics, are sent to the Validation Server. Using the video identification, the Validation Service Provider's API searches through its database of Validation Instances and retrieves any Validation Instances that have a relation to this video identification. For example, if a video advertisement has a Validation Instance that includes a question and multiple-choice answers, this question and multiple-choice answers can be related to the video using the video identification. Other types of database algorithms may be utilized such as searching for Validation Instances that match user demographics and data.

Then, the API will send a response back to the video player or the ad server with the Validation Prompt, which in this case is a question and multiple-choice answers. If, for example, the request was first made through the ad server and not the video player, then the ad server will in turn send the Validation Prompt to the video web site to be loaded within the frame of the video player and can use, but is not limited to, standards that exist for sending video ad XML wrappers such as VAST and VPAID.

In an example of how to validate the Success of the Validation Instance 708 when a user interacts with a Validation Instance, which in this example involves answering a question, the answer and other parameters, including, but not limited to, a validation identification, validation parameters (such as an answer or interaction), video identification, video web site, user information that may have been stored in a cookie or carried across a persistent login, and demographics, can be sent to an ad server. This could be subsequently sent to a Validation Service Provider server or Validation Server or directly to a Validation Service Provider server or Validation Server for validation. This could be accomplished using server side scripting including, but not limited to, PHP and Java.

Using a validation identification, the Validation Instance can be compared against the database records. For example, if the Validation Instance required “Answer 2” to be selected by the user, the request sent to the Validation Server will include this answer as a parameter, along with the validation identification, and compare this with the data in the database. If these parameters match the parameters in the database (if the answer is correct for this Validation Instance), then the user may be rewarded.

In an example of how to track rewards 710 and 711, each user that has an account with a Validation Service Provider could have a unique identification for use by the API. When a user interaction is made and validated by the Validation Service Provider's API, there will be a user with an identification that is related to this interaction. If a user has a cookie or a persistent login that is sent through the API when an interaction is made, then this user can be recognized during the validation process and rewarded appropriately. If a user is not logged in, they will have an opportunity to login and therefore establish a relationship between their interaction and their account. If a user does not have account, measures will be taken to temporarily store certain interactions by using identification data including, but not limited to, cookies, IP addresses, or MAC addresses. Then, this user will be able to associate any previous interactions and rewards that are still stored in the database with this identification.

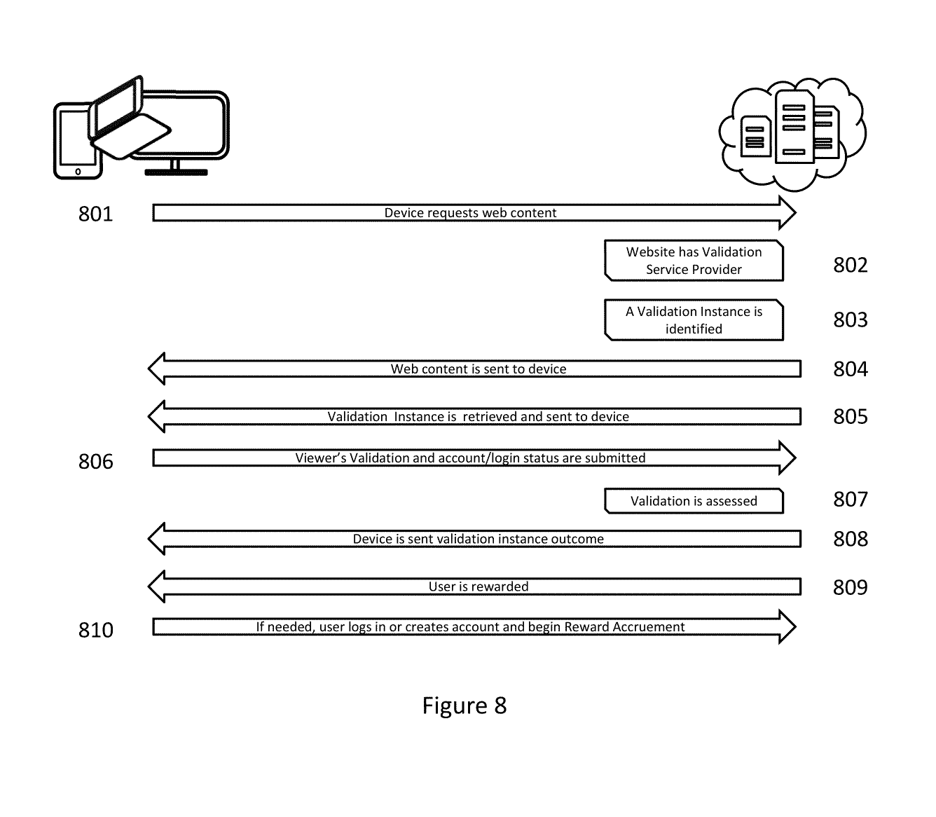

The following is a description (illustrated by FIG. 8) of one implementation of the process by which the correct Validation Instance is selected during the browsing of web content, the submitted response by the user is evaluated, and, if necessary, the user is rewarded. Once the viewer browses web content, a request is sent to the web server 801. The web server determines that it has a Validation Service Provider 802. A Validation Prompt is identified to be sent to the device that could be related to content viewed before, during or after the current browsing session 803. In one implementation of this, a match between a unique identifier of the web content with a Validation Instance stored in a database in the Validation Server would notify the web server of that match.

Then the web content is sent to the device 804 and the Validation Prompt is retrieved and sent to the device 805. Once these have been received, the user submits a Validation Instance along with account or login information to the Validation Server 806. The Validation Server assesses whether or not the validation submitted by the user successfully meets the success criteria 807. The device is then notified of the outcome of the submission, for instance, whether or not the user was successful 808. For the purposes of this example, the user successfully completes the Validation Instance. For successful completion of this example of a Validation Instance, the user is rewarded 809. Finally, if needed, the user can either login or create an account in order to gain rewards through Reward Accruement 810.

In an implementation of this invention that would coincide with the processes outlined in FIG. 8 it is necessary to retrieve the Validation Instance 805, validate the Success of the Validation Instance 807, and track rewards 809 and 810. In an example of how to retrieve a Validation Instance 805 as a user is browsing web content, the web server will make an API request to the Validation Server using server side scripting including, but not limited to, PHP and Java. Some common functionality of this API could include, but is not limited to, functions to retrieve Validation Instances associated with web content identifications, compare Validation Instances against the Validation Service Provider's database, reward users based on Validation Instances, and retrieve user data including, but not limited to, reward balances and Validation Instance interaction statistics. In this API request, parameters, including but not limited to, a content identification, a web site, user information that may have been stored in a cookie or carried across a persistent login, and demographics, are sent to the Validation Server. Using the web content identification, the Validation Service Provider's API searches through its database of Validation Instances and retrieves any Validation Instances that have a relation to this web content identification. For example, if web content has a Validation Instance that includes a question and multiple-choice answers, this question and multiple-choice answers can be related to the web content using the web content identification. Other types of database algorithms may be utilized such as searching for Validation Instances that match user demographics and data. Then, the API will send a response back to the device or the web server with the Validation Instance, which in this case is a question and multiple-choice answers.

In an example of how to validate the Success of the Validation Instance 807 when a user interacts with a Validation Prompt, which in this example involves answering a question, this answer and other parameters including, but not limited to, a validation identification, validation parameters (such as an answer or interaction), web content identification, web site, user information that may have been stored in a cookie or carried across a persistent login, and demographics, can be sent to an web server. This can subsequently be sent to a Validation Service Provider server or Validation Server or directly to a Validation Service Provider server or Validation Server for validation. This can be accomplished using server side scripting including, but not limited to, PHP and Java.

Using a validation identification, the Validation Instance can be compared against the database records. For example, if the Validation Instance required “Answer 1” to be selected by the user, the request sent to the Validation Server will include this answer as a parameter, along with the validation identification, and compare this with the data in the database. If these parameters match the parameters in the database (if the answer is correct for this Validation Instance), then the user may be rewarded.

In an example of how to track rewards 809 and 810, each user that has an account with a Validation Service Provider has a unique identification that is used by the API. Whenever a user interaction is made and validated by the Validation Service Provider's API, there will be a user with an identification that is related to this interaction. If a user has a cookie or a persistent login that is sent through the API when an interaction is made, then this user can be recognized during the validation process and rewarded appropriately. If a user is not logged in, they will have an opportunity to log in and therefore establish a relationship between their interaction and their account. If a user does not have account, measures will be taken to temporarily store certain interactions by using identification data including, but not limited to, cookies, IP addresses, or MAC addresses. Then, this user will be able to associate any previous interactions and rewards that are still stored in the database with this identification.

In an embodiment of this invention, businesses who choose to utilize the outlined service, may, but are not limited to, paying for the service in a manner that is dependent on the specific actions taken by the user. In one illustrative implementation, a business may pay on a “Cost-Per-Correct-Answer” or (“CPCA” herein) basis. In such an embodiment, the business may choose to utilize any of the aforementioned aspects of this invention, however their payment for the service would be contingent upon a correct engagement with the Validation Instance in order to verify that the user comprehends the information being displayed by the business.

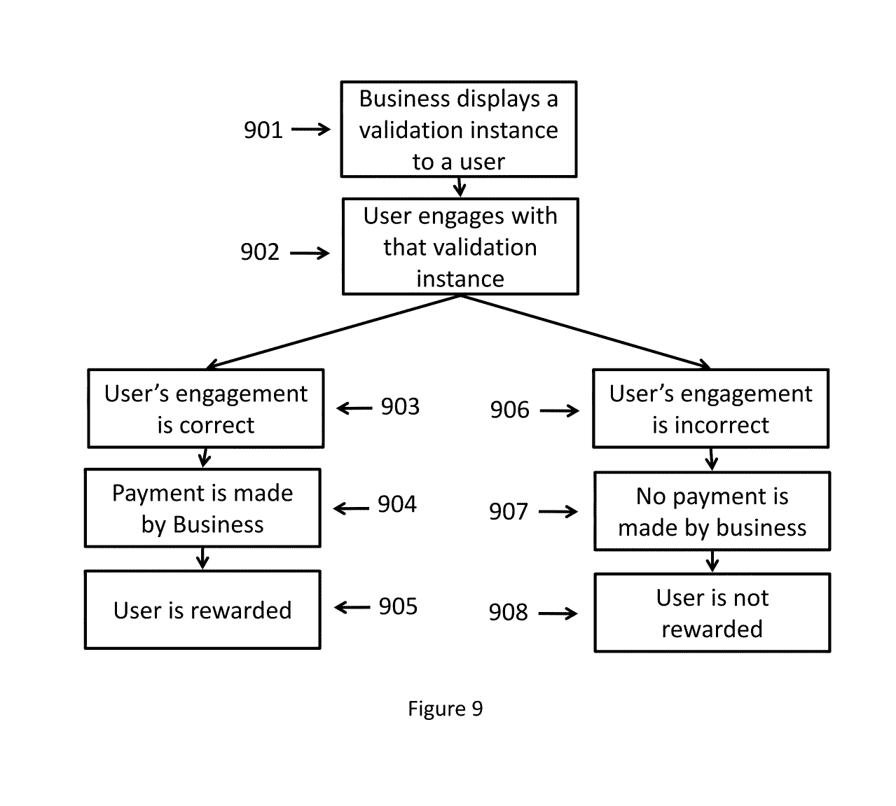

FIG. 9 is a flowchart showing one implementation of the process by which the business chooses to pay for the services outlined above on a “Cost-Per-Correct-Answer” (or CPCA) basis. First, the business displays Validation Prompt 901 to the user. Next, the user makes engagement 902 with the Validation Prompt. This engagement may include, but is not limited to, selecting one response on a multiple choice question, filling out a text box, matching an image, etc. Next, it is determined whether or not the user's engagement correctly satisfies the Validation Instance posed by the business by comparing the engagement of the user to predetermined correct engagements. If the user's engagement is correct 903, then the business will make payment 904 for the correct engagement, and the user will be given a reward 905 for their correct engagement. This reward may include, but is not limited to, a percentage of the currency paid by the business, online points, online currency, coupons, exclusive offers, etc. If engagement taken by the user is incorrect 906, then the business will not make payment 907, and the user will not be given reward 908. In this example, the business is not only given the ability to display a Validation Prompt with a piece of online content, the business is able to pay for that Validation Instance when the user correctly engages with the Validation Instance.

In the foregoing description, certain steps or processes can be performed on particular servers or as part of a collection of servers. These descriptions are merely illustrative, as the specific steps can be performed on various hardware devices, including, but not limited to, server systems and/or mobile devices. Similarly, the division of where the particular steps are performed can vary, it being understood that no division or a different division is within the scope of the invention.

The techniques and systems disclosed herein may be implemented as a computer program product for use with a computer system or computerized electronic device. Such implementations may include a series of computer instructions, or logic, fixed either on a tangible medium, such as a computer readable medium (e.g., a diskette, CD-ROM, ROM, flash memory or other memory or fixed disk) or transmittable to a computer system or a device, via a modem or other interface device, such as a communications adapter connected to a network over a medium.

The medium may be either a tangible medium (e.g., optical or analog communications lines) or a medium implemented with wireless techniques (e.g., Wi-Fi, cellular, microwave, infrared or other transmission techniques). The series of computer instructions embodies at least part of the functionality described herein with respect to the system. Those skilled in the art should appreciate that such computer instructions can be written in a number of programming languages for use with many computer architectures or operating systems.

Furthermore, such instructions may be stored in any tangible memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

What is claimed is:

1. A method of evaluating a level of user understanding of video content, the method comprising:
receiving information characterizing a video content item;
selecting a validation prompt based on the information characterizing the video content item;
providing the validation prompt for presentation to the user;
receiving user input in response to the validation prompt;
evaluating the user input against predetermined evaluation criteria corresponding to the validation prompt; and
recording a result of the evaluation of the user input.

2. The method of claim 1, the evaluation criteria including a correct answer, and wherein the recording the evaluation of the user input includes recording a reward credited to the user upon a condition in which the result indicates the user input matches the correct answer.

3. The method of claim 1, the evaluation criteria including a correct answer and at least one incorrect answer, and wherein the recording the evaluation of the user input includes one of the following:
recording a first reward credited to the user upon a condition in which the result indicates the user input matches the correct answer, or
recording a second reward credited to the user upon a condition in which the result indicates the user input matches one of the incorrect answers.

4. The method of claim 1, the reward including a monetary credit deposited in an account associated with the user.

5. The method of claim 1, the video content item being provided by a video content provider, the method further comprising informing the video content provider of the result.

6. The method of claim 5, the validation prompt being provided by a validation prompt provider, the method further comprising the validation prompt provider receiving a monetary credit from the video content provider in response to the informing the video content provider of the result.

7. The method of claim 5, the evaluation criteria including a correct answer, and the validation prompt being provided by a validation prompt provider, the method further comprising the validation prompt provider receiving a monetary credit from the video content provider upon a condition in which the result indicates the user input matches the correct answer.

8. The method of claim 1, the providing the validation prompt for presentation to the user including displaying the validation prompt before, during, or after the display of the video content item.

9. The method of claim 1, the validation prompt being displayed on at least one of a mobile computing device, smartphone, tablet computing device, television system, and Internet access device.

10. The method of claim 1, the video content item including at least one of an advertisement, television program, movie, web clip, website, blog, photograph, image, collection of text, and graphics.

11. The method of claim 1, the validation prompt including a multiple choice question.

12. The method of claim 1, the validation prompt including a task for the user to complete, the task including at least one of (i) matching at least one similar image with a presented image, (ii) ordering images according to an instruction set, and (iii) selecting an image from a plurality of images, (iv) completing a text input, and (v) unscrambling a word or sentence.

13. A system for evaluating a level of user understanding of video content, the system comprising:
logic for receiving information characterizing a video content item;
logic for selecting a validation prompt based on the information characterizing the video content item;
logic for providing the validation prompt for presentation to the user;
logic for receiving user input in response to the validation prompt;
logic for evaluating the user input against predetermined evaluation criteria corresponding to the validation prompt; and
logic for recording a result of the evaluation of the user input.

14. The system of claim 13, the evaluation criteria including a correct answer, and wherein the logic for recording the evaluation of the user input includes logic for recording a reward credited to the user upon a condition in which the result indicates the user input matches the correct answer.

15. The system of claim 13, the evaluation criteria including a correct answer and at least one incorrect answer, and wherein the logic for recording the evaluation of the user input includes the following:
logic for recording a first reward credited to the user upon a condition in which the result indicates the user input matches the correct answer, and
logic for recording a second reward credited to the user upon a condition in which the result indicates the user input matches one of the incorrect answers.

16. The system of claim 13, the reward including a monetary credit deposited in an account associated with the user.

17. The system of claim 13, the video content item being provided by a video content provider, the system further comprising logic for informing the video content provider of the result.

18. The system of claim 17, the validation prompt being provided by a validation prompt provider, the system further comprising logic for causing the validation prompt provider to receive a monetary credit from the video content provider in response to the informing the video content provider of the result.

19. The system of claim 17, the evaluation criteria including a correct answer, and the validation prompt being provided by a validation prompt provider, the system further comprising logic for causing the validation prompt provider to receive a monetary credit from the video content provider upon a condition in which the result indicates the user input matches the correct answer.

20. The system of claim 13, the logic for providing the validation prompt for presentation to the user including logic for displaying the validation prompt before, during, or after the display of the video content item.

21. The system of claim 13, the validation prompt being displayed on at least one of a mobile computing device, smartphone, tablet computing device, television system, and Internet access device.

22. The system of claim 13, the video content item including at least one of an advertisement, television program, movie, web clip, website, blog, photograph, image, collection of text, and graphics.

23. The system of claim 13, the validation prompt including a multiple choice question.

24. The system of claim 13, the validation prompt including a task for the user to complete, the task including at least one of (i) matching at least one similar image with a presented image, (ii) ordering images according to an instruction set, and (iii) selecting an image from a plurality of images, (iv) completing a text input, and (v) unscrambling a word or sentence.
